(19) United States
(12) Patent Application Publication
(10) Pub. No.: US 2009/0070400 A1
(43) Pub. Date: Mar. 12, 2009

(54) CARRY-SELECT ADDER

(75) Inventor: Steven Leeland, Scottsdale, AZ (US)

Correspondence Address: HENNEMAN & ASSOCIATES, PLC, 714 W. MICHIGAN AVE., THREE RIVERS, MI, 49093, US

(73) Assignee: TECHNOLOGY PROPERTIES LIMITED, Cupertino, CA (US)

(21) Appl. No.: 11/854,242

(22) Filed: Sep. 12, 2007

(51) Int. Cl. G06F 7/50

(52) U.S. Cl. 708/706

(57) ABSTRACT

A carry select adder to add two binary addends to produce a binary sum. In a first section a first addition block adds 6-bit addend slices having 3-bit lower-half and higher-half slices. A first adder block receives and adds the lower-half slices and outputs an adder-carry-out and a 3-bit lower-half value. A zero-carry-loaded second adder block receives and adds the higher-half slices and outputs a 4-bit zero-related intermediate-value. A one-carry-loaded third adder block receives and adds the higher-half slices and outputs a 4-bit one-related intermediate-value. A 4-bit multiplexer then passes either the zero-related intermediate-value or the one-related intermediate-value as a 1-bit section-carry-out and a 3-bit higher-half value based on the adder-carry-out, wherein the higher-half value and the lower-half value form a 6-bit sum slice corresponding to the 6-bit addend slices.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Technical Field

The present invention relates generally to electrical computers that perform arithmetic processing and calculating, and more particularly to such wherein numerical digits are added in a simultaneous manner.

2. Background Art

Addition is a basic operation, one often especially determinative of how fast a computer processor can perform a useful task. Digital circuits to perform logical operations such as addition are already well known in the art that employ a number of different techniques to implement multi-bit adders, and usually an important consideration in such a circuit is how to handle a carry when summing two multi-bit binary numbers. Simply stated, the sum at any bit position must include a carry from any (previous) lower-order bit position or, equivalently stated, the sum at any bit position depends upon all of the lower-order bit inputs.

For example, in the common ripple-carry technique the bit-position sums and carry-values for the next bit are calculated sequentially in time, beginning with the least significant bit and ending with the most significant bit. This tends to result in slow calculation speed, but also in smaller circuit area and lower power consumption. In contrast, higher operating speeds may be obtained by using logic-array based techniques that calculate all of the bit-positions simultaneously in parallel (see e.g., WEINBERGER, “High-Speed Programmable Logic Array Adders,” IBM Journal of Research and Development, Vol. 23, No. 2, pp. 163-78 (1979)). These techniques, however, tend to require a large circuit area and to consume more power. Several techniques are also known that employ a partial degree of parallelism, such as carry-select techniques (see e.g., BEDRIJ, “Carry-Select Adder,” IRE Transaction on Electronic Computers, Vol. EC-11, pp. 340-46, 1962). Yet further are hybrids and mixes of the various techniques, but these are typically tailored for signal environments using a word size that is a multiple of 8-bits, such as 16-, 32-, 64-, and 128-bit word sizes.

In view of the importance of addition in computer processing and the unfortunate tradeoffs that tend to be imposed by the prior art schemes used in digital circuits, it remains desirable to have new adders that are fast, flexible, efficient, and adaptable to emerging technologies. For example, without limitation, such a new adder should be capable of operation at speeds equaling or exceeding common adders today, of performing operations on various word sizes (e.g., 9-bit or 18-bit words), of using die area and power sparingly, and of being capable in multiprocessor arrays and embedded systems applications.

### BRIEF SUMMARY OF THE INVENTION

Accordingly, it is an object of the present invention to provide an improved carry-select adder.

Briefly, one preferred embodiment of the present invention is a carry select adder for adding two binary addends to produce a binary sum. A section forming an addition block is provided to add 6-bit addend slices from the addends that each include a 3-bit lower-half slice and a 3-bit higher-half slice. This section/addition block includes a three adder blocks and a 4-bit multiplexer. The first adder block receives and adds the lower-half slices and outputs a 1-bit adder-carry-out and a 3-bit lower-half value. The second adder block is zero-carry-loaded, and it receives and adds the higher-half slices, and outputs a 4-bit zero-related intermediate-value. The third adder block is one-carry-loaded and it receives and adds the higher-half slices, and outputs a 4-bit one-related intermediate-value. The multiplexer then passes either the zero-related intermediate-value or the one-related intermediate-value as a 1-bit section-carry-out and a 3-bit higher-half value based on the adder-carry-out. The higher-half value and the lower-half value thus form a 6-bit sum slice corresponding to the 6-bit addend slices.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1A-B are schematic block diagrams of a first exemplary 18-bit embodiment of a carry-select (CS) adder that is in accordance with the present invention, wherein FIG. 1A shows the CS adder in detail and FIG. 1B shows the CS adder with references used in the discussion.

FIG. 2 is a schematic diagram depicting the internal construction of a 3-bit combinatorial adder block used in the CS adder.

FIG. 3 is a timing diagram of CS adder in FIG. 1A-B showing signal propagation through the stages after digital signals representing input variables are presented at the input nets and the carry-in line.

FIG. 4 is a schematic block diagram depicting an alternate embodiment of the inventive CS adder that may be preferred in applications where the underlying technology has significant wire delay.

In the various figures of the drawings, like references are used to denote like or similar elements or steps.

### DETAILED DESCRIPTION OF THE INVENTION

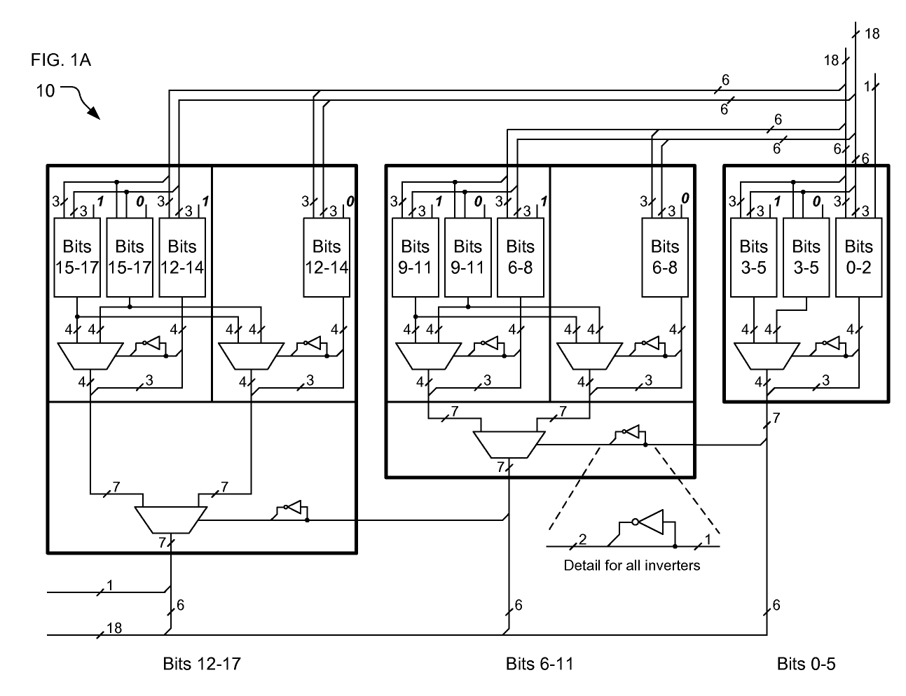

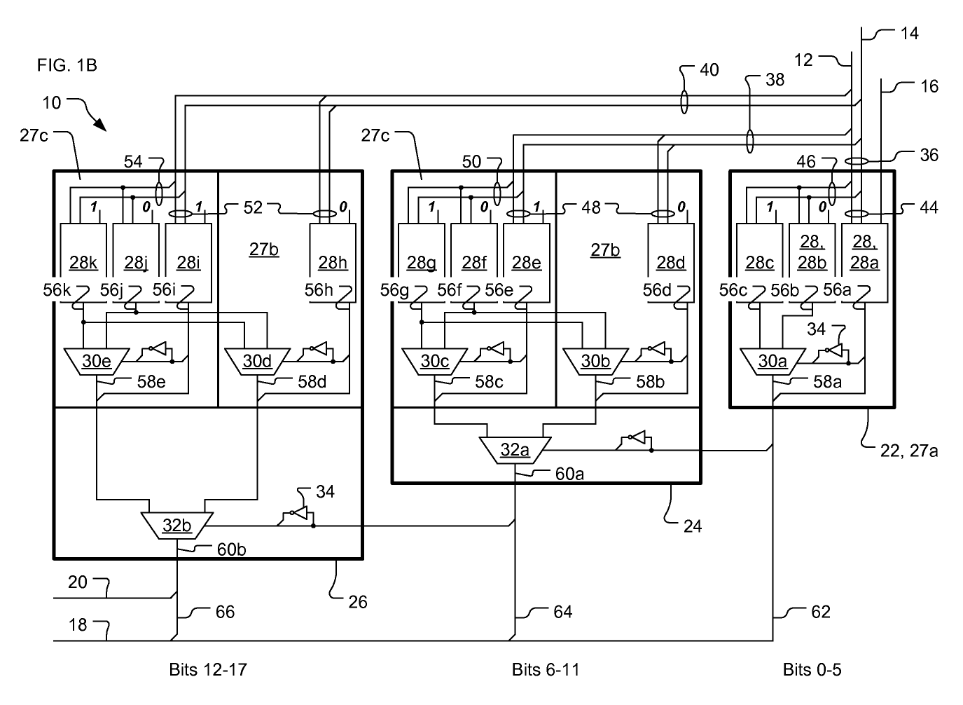

A preferred embodiment of the present invention is a carry-select (CS) adder. As illustrated in the various drawings herein, and particularly in the views of FIG. 1A-B, preferred embodiments of the invention are depicted by the general reference character 10.

The present invention provides a high speed carry-select adder (CS adder 10). It employs 3-bit smallest adder blocks which are fast adders basically having two-gate-delay performance and parallel carry selection recursively in 6-bit stages.

Briefly, two 18-bit exemplary embodiments of the CS adder 10 are presented as examples herein. Both operate on two binary 18-bit (or smaller) addend words to provide a 1-bit carry-out and a binary 18-bit sum word. For the sake of discussion, the 18-bit numbers are viewed as three 6-bit slices that each include a higher-half 3-bit slice and a lower- half 3-bit slice. At least one 3-bit adder block is used for each 3-bit slice of the addend words. One such adder block is used for the lowest, lower-half 3-bit slice (bits 0-2) and arrangements of duplicated 3-bit adder blocks are used for the more significant bits (bits 3-17). In the first of these embodiments, eleven total 3-bit adder blocks are used and in the second fifteen total 3-bit adder blocks are used.

Although the inventive CS adder 10 can also be implemented in other word size embodiments, e.g., to handle 12-bit or 24-bit word sizes, the inventors' presently preferred embodiment is an 18-bit device using combinatorial 3-bit adder blocks. This particularly overcomes the shortcomings of prior art devices, which are typically designed for signal environments using multiples of 8-bits. This has also proven especially adaptable for use in single-chip multiprocessor arrays, thus permitting embodiments of the inventive CS adder 10 to serve very well in such devices made by the present inventors' employer.

FIG. 1A-B are schematic block diagrams of a first exemplary 18-bit embodiment of a CS adder 10 that is in accordance with the present invention. FIG. 1A shows the CS adder 10 in detail and FIG. 1B shows the CS adder 10 with references used in the following discussion.

The CS adder 10 accepts three inputs and provides two outputs. The inputs include a first 18-bit addend word provided on a first input net 12, a second 18-bit addend word provided on a second input net 14, and an (optional) 1-bit carry-in provided on a carry-in line 16. The outputs include an 18-bit sum word provided on a result net 18, and a 1-bit carry-out provided on a carry-out line 20.

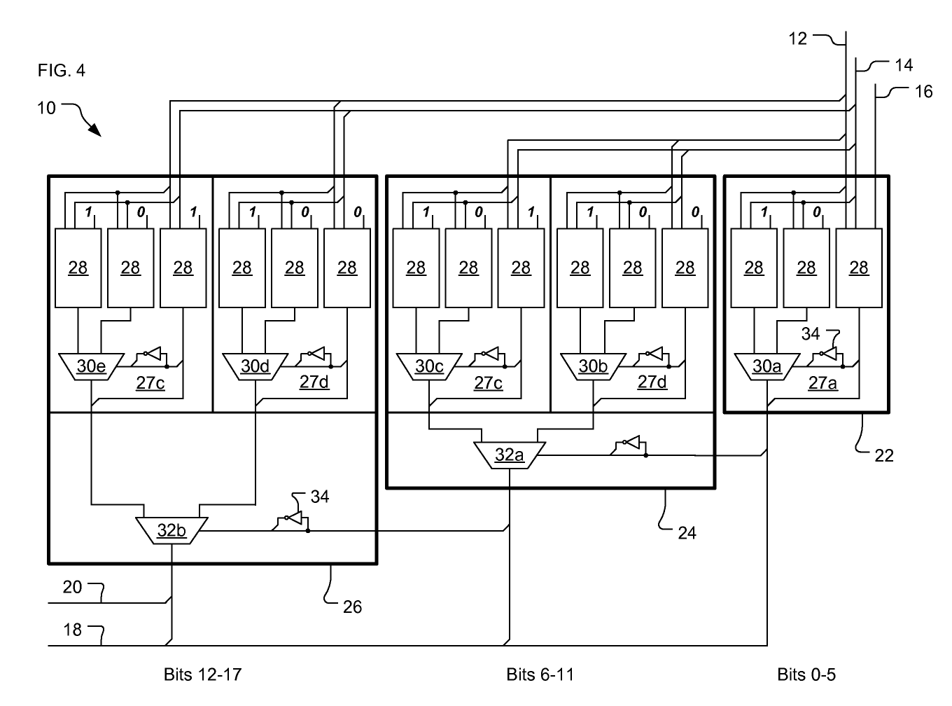

Referring briefly also to FIG. 4, the two embodiments of the CS adder 10 discussed herein each have three major sections 22, 24, 26 which include arrangements of four types of 6-bit addition blocks 27a-d. Addition block 27a is not “carry-loaded” meaning that it can accept either a one or a zero on the carry-in line 16. [If a CS adder 10 will never need to accept a carry-in, an instance of addition block 27d can be used in place of addition block 27a]. In contrast, addition block 27b (particular to the embodiment in FIG. 1A-B) is “zero-loaded,” meaning that it is “hard-wired” to use a zero carry-in value in its lowest order adder block. In further contrast, addition block 27c is “one-loaded,” meaning that it is “hard-wired” to use a one carry-in value in its lowest order adder block. And addition block 27d (particular to the embodiment in FIG. 4) is also “zero-loaded,” albeit using a different internal components arrangement discussed presently. With reference to the figures, it can be appreciated that section 22 and addition block 27a are one and the same, and that sections 24, 26 both include either an addition block 27b and an addition block 27c or else an addition block 27d and an addition block 27c. Viewing the sections 22, 24, 26 and the addition blocks 27a-d in this manner emphasizes the recursive aspect of the inventive CS adder 10, discussed further presently.

Turning now just to FIG. 1A-B, here the sections 22, 24, 26 include eleven combinatorial adder blocks (collectively adder blocks 28, individually adder blocks 28a-k), five 4-bit 2-to-1 multiplexers 30a-e, two 7-bit 2-to-1 multiplexers 32a-b, and respective inverters 34 for each multiplexer 30a-e, 32a-b.

The two 18-line input nets 12, 14 separate (divide) into three subnets 36, 38, 40 that carry 6-bit slices of the first and second addends to each section 22, 24, 26. Thus, bits 0-5 of both addends are delivered to section 22; bits 6-11 of both addends are delivered to section 24; and bits 12-17 of both addends are delivered to section 26, as shown. The 1-bit carry-in on the carry-in line 16, if provided, is also delivered to section 22.

In section 22 the 6-line portions of the subnet 36 separate (divide) into two 3-line subnets 44, 46 as shown. The subnet 44 delivers three lower order bits (i.e., the lower-half 3-bit slice of the lowest 6-bit slice, here bits 0-2) of both addends to adder block 28a and the subnet 46 delivers three higher order bits (i.e., the higher-half 3-bit slice of the same 6-bit slice, here bits 3-5) of both addends to both adder block 28b and adder block 28c. The 1-bit carry-in provided on the carry-in line 16 is delivered to adder block 28a, and adder block 28b and adder block 28c have “hard-wired” inputs of 1 or 0, as shown.

Similarly, in section 24 the 6-line portions of the subnet 38 separate (divide) into two 3-line subnets 48, 50 as shown. And in section 26 the 6-line portions of the subnet 40 separate (divide) into two 3-line subnets 52, 54 as shown. In sections 24, 26, however, the adder blocks 28d-k all have “hard-wired” inputs of either 1 or 0, as shown.

Viewing the sections 22, 24, 26 collectively now, each of the adder blocks 28 feeds a respective 4-line subnet (collectively subnets 56, individually subnet 56a-k); each of the 4-bit multiplexers 30a-e feeds a respective 4-line subnet 58a-e; and each of the two 7-bit multiplexers 32a-b feeds a respective 7-line subnet 60a-b. The effective accomplishment of all of this, discussed from a functional perspective presently, is that section 22 feeds into a subnet 62, section 24 feeds into a subnet 64, section 26 feeds into a subnet 66, and these subnets 62, 64, 66 combine into the result net 18.

Consider adder block 28a. The two 3-line sections in subnet 44 feed it with the value of bits 0-2 (the three least significant bits (LSB)), and the carry-in line 16 feeds it with the 1-bit carry-in value. It then feeds the 4-line subnet 56a with a 4-bit value comprising the sum of bits 0-2 from each addend and an adder-carry-out bit.

Next consider adder block 28b and adder block 28c. The two 3-line sections in subnet 46 feed both with the values of bits 3-5 in the addends. Rather than work with an actual carry value, however, adder block 28b is “hard-wired” to use a zero value and adder block 28c is “hard-wired” to use a one value. In this manner, adder block 28b and adder block 28c calculate both possibilities in parallel, respectively feeding 4-line subnet 56b and subnet 56c with 4-bit intermediate-values comprising the possible sums of bits 3-5 from each addend.

The multiplexer 30a receives both intermediate-values from adder block 28b and adder block 28c on the subnet 56b and subnet 56c, and based on the adder-carry-out bit on subnet 56a (via the inverter 34) passes the appropriate intermediate-value to 4-line subnet 58a. [It should be noted that the multiplexers 30a-e, 32a-b in the exemplary embodiments herein are chosen to require a 2-line “select” input with a two digit binary value of either 1 0 or 0 1. Accordingly, an inverter 34 at each multiplexer 30a-e, 32a-b, converts a 1-bit carry-in signal to a 2-bit carry-select signal. But other designs are also usable.] Thus, section 22 outputs a 7-bit value wherein the three low-order bits come from subnet 56a and the four high-order bits come from subnet 58a. Specifically, section 22 outputs a 6-bit sum slice of the corresponding 6-bit added slices, in this case bits 0-5 of both addends, and a 1-bit section-carry-out value. The 6-bit sum slice goes onto subnet 62, and becomes bits 0-5 in the ultimate result on result net 18, and the 1-bit section carry-out value is used by section 24. Continuing the lower-half, higher-half protocol used when discussing the input slices, this 6-bit sum slice can be viewed as including a higher-half 3-bit slice and a lower-half 3-bit slice.

The rest of the adder blocks 28d-k are used in paired arrangements much like adder blocks 28b-c. The adder blocks 28d-e handle bits 6-8; adder blocks 28f-g handle bits 9-11; adder blocks 28h-i handle bits 12-14; and adder blocks 28j-k handle bits 15-17, as shown in FIG. 1A-B.

Now consider section 24. There adder blocks 28d-e calculate the possible sums of bits 6-8 from each addend, and then multiplexer 32a passes the appropriate sub-result onto subnet 64 based on the 1-bit section-carry-out value from section 22. Concurrently, adder blocks 28f-g calculate the possible sums of bits 9-11 from each addend and provide these intermediate-values to multiplexers 30b-c, which then each pass one possibility, based on the respective adder-carry-out bits on subnets 56d-e, from which the correct one is passed by multiplexer 32a, based still on the 1-bit section-carry-out value from section 22. Thus, section 24 also outputs a 7-bit value, one that is a 6-bit sum slice of summing bits 6-11 of both addends and a 1-bit carry-out value. The 6-bit sum slice goes onto subnet 64, and becomes bits 6-11 in the ultimate result on result net 18, and the 1-bit section-carry-out value is used by section 26. Again, this 6-bit sum slice can also be viewed as including a higher-half 3-bit slice and a lower-half 3-bit slice.

The same technique is used in section 26, only now to calculate a 7-bit value that is a 6-bit sum slice of bits 12-17 of both addends and a 1-bit section-carry-out value. The 6-bit sum slice goes onto subnet 66, and becomes bits 12-17 in the ultimate result on result net 18, and the 1-bit section-carry-out value is output on the carry-out line 20. And again, this 6-bit sum slice can be viewed as including a higher-half 3-bit slice and a lower-half 3-bit slice.

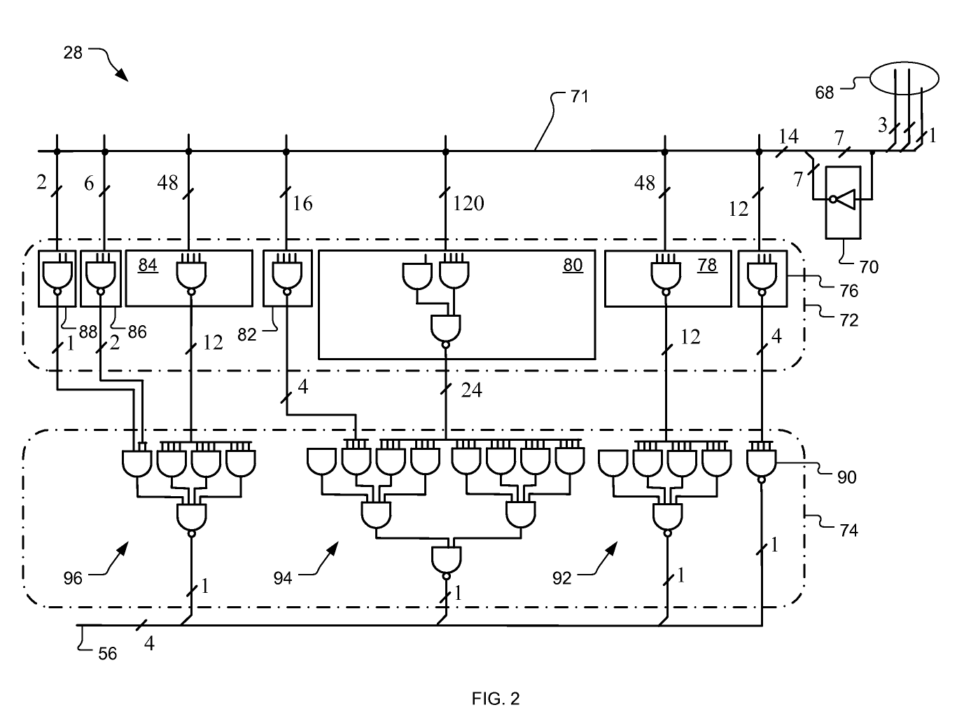

FIG. 2 is a schematic diagram depicting the internal construction of a 3-bit combinatorial adder block 28. The major elements in the adder block 28 are a seven-line input net 68, an inverter array 70, a fourteen-line input net 71, an AND plane 72 of gates, and an OR plane 74 of gates. The basic gates are essentially conventional and can have up to four inputs, so NAND gates with more inputs are built up from several 4-input AND gates connecting to a NAND gate.

The input net 68 includes two 3-line subnets and one carry-in line (seven lines in all) that receive corresponding particular 3-bit slices of the two addend words, and a carry-in bit. The carry-in bit can be “hard wired” to either 0 or 1, as described hereinabove; and in the case of adder block 28a, it will be the 1-bit carry-in provided on carry-in line 16. The inverter array 70 has seven inverters that connect to input net 68 and provide inverted values on seven inverter output lines. These inverter output lines are combined with input net 68 to form a fourteen-line complemented input net 71, which feeds seven un-inverted and seven inverted input bits and carry-in values to the AND plane 72.

The AND plane 72 includes several constructions of 2-, 3-, 4-, and 5-input NAND gates, specifically including a NAND array 76 that is four 3-input NAND gates; a NAND array 78 that is twelve 4-input NAND gates; a NAND array 80 of twenty-four 5-input NAND gates; a NAND array 82 of four 4-input NAND gates; a NAND array 84 of twelve 4-input NAND gates; a NAND array 86 of two 3-input NAND gates; and one 2-input NAND gate 88.

The OR plane 74 also includes several constructions of multi-input NAND gates, specifically including a 4-input NAND gate 90; a 12-input NAND gate 92, a 28-input NAND gate 94; and a 15-input NAND gate 96.

On the input side of the AND plane 72, the 252 inputs to the NAND gates are connected to particular lines of the input net 71, as needed according to known Boolean equations for bit sums and look-ahead carry values. This provides 59 outputs, which are grouped by the sum bit being computed, to the OR plane 74.

Accordingly, the 4-line output net of NAND array 76 connects to the 4-input NAND gate 90 to compute the bit-0 sum; the 12-line output net of NAND array 78 connects to the 12-input NAND gate 92 to compute the bit-1 sum; the 24-line output net of NAND array 80 and the 4-line output net of NAND array 82 connect to the 28-input NAND gate 94 to compute the bit-2 sum; and the 1-line, 2-line, and 12-line outputs of NAND arrays 88, 80, 82, respectively, connect to the 15-input NAND gate 96 to compute the carry out. The four output lines of the OR plane 74 then join to form the 4-line output subnet 56 of the 3-bit combinatorial adder block 28.

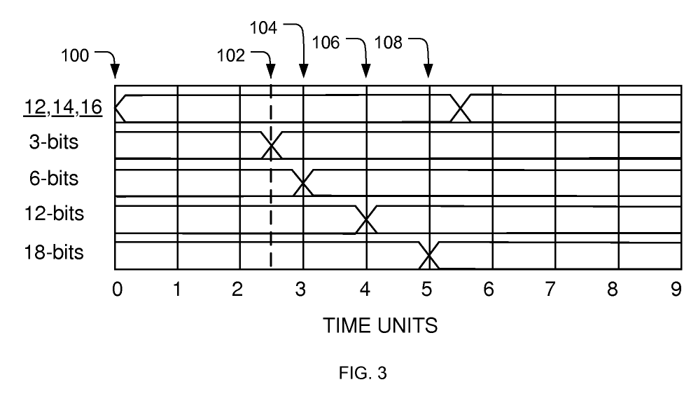

FIG. 3 is a timing diagram of a CS adder 10 showing signal propagation through the stages after digital signals representing input variables are presented at the input nets 12, 14 and the carry-in line 16. The topmost trace in the diagram shows a signal level transition at time 100 (zero time), and the timing and the signal levels at various points in the CS adder 10 are shown by the other graph traces.

The signal transition at the outputs of the 3-bit combinatorial adder blocks 28a-k, at subnets 56a-k, are shown in the next graph trace, labeled “3-bits.” This is time 102, at 2.5 time units, and it reflects the computation delay time of a 3-bit combinatorial adder block 28.

The next lower trace, labeled “6-bits,” shows the signal transition of the 4-line subnets 58a-e below the 4-bit multiplexers 30a-e. This is time 104, at three time units. The difference between time 102 and time 104 thus represents the time delay introduced by a 4-bit multiplexer, for example multiplexer 30a.

The further lower trace, labeled “12-bits,” shows the signal transition of the 7-line subnet 60a below the first 7-bit multiplexer 32a. This is time 106, at four time units. The difference between time 104 and time 106 thus represents the time delay of multiplexer 32a.

It should be noted that the carry-out to bit-12 becomes available at time 106, not earlier, and accordingly the high-order 6-bits of the 18-bit sum require another 7-bit multiplexer delay. The bottom trace, labeled “18-bits,” therefore shows the signal transition at subnet 60b of multiplexer 32b. This is time 108, at 5 time units.

It should be understood that the different components of the CS adder 10, comprising the adder blocks 28, multiplexers 30, 32, and inverters 34, are themselves composed of basic gates and circuit elements as known in the art, and can have characteristic delay times according to their types. The times shown in FIG. 3 are therefore approximate, and are chiefly shown for the purpose of clarifying the operation of the 18-bit CS adder 10.

FIG. 4 is a schematic block diagram depicting an alternate embodiment of the inventive CS adder 10 that may be preferred in applications where the underlying technology has significant wire delay. To reduce wire delay owing to shared input connections between 4-bit multiplexers in sections 24, 26, this approach employs more adder blocks 28 to permit closer connection from the adder blocks to the 4-bit multiplexers 30b and 30d. All other aspects of the construction and operation of the CS adder 10, however, can remain substantially the same as described above.

Summarizing, the inventive CS adder 10 handles a carry-in and provides a carry-out and is suitable for various word lengths (particularly including eighteen bit words). Extremely high speed is achieved using the approach of multiplexing between two possible carry results computed in the MSB adder blocks simultaneously, and then selected by a carry computation from the LSB adder block. Adder sections are made recursively of smaller adder blocks. Unlike the conventional approach, however, where smallest blocks are brought down to the 1-bit level, the inventive CS adder 10 employs a 3-bit smallest adder block in a novel and particularly efficient manner that provides extremely high speed (basically two gate delays for the computation of the 3-bit results and carries-out, simultaneously in parallel).

Of course, in alternate embodiments of the inventive CS adder 10, other types of 3-bit adders can be employed in place of the 3-bit combinatorial adder blocks 28 described above. In particular, 3-bit ripple carry adders can be used, without otherwise altering the structure. It will also be apparent to those skilled in the art that, with appropriate modifications, other known multiplexer types may alternatively be used in other embodiments of the CS adder 10.

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. A carry select adder for adding two binary addends to produce a binary sum, comprising:
a first section having a first addition block to add 6-bit addend slices from the addends that each include a 3-bit lower-half slice and a 3-bit higher-half slice, said first addition block including:
a first adder block that receives and adds said lower-half slices and outputs a 1-bit adder-carry-out and a 3-bit lower-half value;
a second adder block that is zero-carry-loaded, that receives and adds said higher-half slices, and that outputs a 4-bit zero-related intermediate-value;
a third adder block that is one-carry-loaded, that receives and adds said higher-half slices, and that outputs a 4-bit one-related intermediate-value;
a first 4-bit multiplexer that passes either said zero-related intermediate-value or said one-related intermediate-value as a 1-bit section-carry-out and a 3-bit higher-half value based on said adder-carry-out; and
wherein said higher-half value and said lower-half value form a 6-bit sum slice corresponding to said 6-bit addend slices.

2. The carry select adder of claim 1, wherein:
said first adder block further receives a 1-bit carry-in value.

3. The carry select adder of claim 1, further comprising:
at least one second section to add additional said 6-bit addend slices, said second section including:
a second addition block to provide a 7-bit zero-related intermediate-result;
a third addition block which includes a said first addition block wherein said first adder block is one-carry-loaded and said section-carry-out thereof, said higher-half value thereof, and said lower-half value thereof form a 7-bit one-loaded intermediate-result; and
a 7-bit multiplexer that passes either said zero-related intermediate-result or said one-related intermediate-result as a 1-bit section-carry-out, an additional higher-half value, and an additional lower-half value based on a said section-carry-out from said first section or another said second section.

4. The carry select adder of claim 3, wherein:
said second addition block includes another said first 4-bit multiplexer controlled by another said second adder block to pass either said zero-related intermediate-value or said one-related intermediate-value from said third addition block to said 7-bit multiplexer.

5. The carry select adder of claim 3, wherein:
said second addition block includes a said first addition block wherein said first adder block is zero-carry-loaded and said section-carry-out thereof, said higher-half value thereof, and said lower-half value thereof form a 7-bit zero-loaded intermediate-result.

6. A carry select adder for adding two binary addends to produce a binary sum, comprising:
a first section having first addition means for adding 6-bit addend slices from the addends having a 3-bit lower-half slice and a 3-bit higher-half slice, said first addition means including:
first adder means for receiving and adding said lower-half slices and outputting a 1-bit adder-carry-out and a 3-bit lower-half value;
second adder means that is zero-carry-loaded, for receiving and adding said higher-half slices, and outputting a 4-bit zero-related intermediate-value;
third adder means that is one-carry-loaded, for receiving and adding said higher-half slices, and outputting a 4-bit one-related intermediate-value;
first 4-bit multiplexing means for passing either said zero-related intermediate-value or said one-related intermediate-value as a 1-bit section-carry-out and a 3-bit higher-half value based on said adder-carry-out; and
wherein said higher-half value and said lower-half value form a 6-bit sum slice corresponding to said 6-bit addend slices.

7. The carry select adder of claim 6, wherein:
said first adder means is further for receiving a 1-bit carry-in value.

8. The carry select adder of claim 6, further comprising:
at least one second section to add additional said 6-bit addend slices, said second section including:
second addition means for calculating a 7-bit zero-related intermediate-result;
third addition means which includes a said first addition means wherein said first adder means is one-carry-loaded and said section-carry-out thereof, said higher-half value thereof, and said lower-half value thereof form a 7-bit one-loaded intermediate-result; and
7-bit multiplexing means for passing either said zero-related intermediate-result or said one-related intermediate-result as a 1-bit section-carry-out, an additional higher-half value, and an additional lower-half value based on a said section-carry-out from said first section or another said second section.

9. The carry select adder of claim 8, wherein:
said second addition means includes another said first 4-bit multiplexing means controlled by another said second adder means for passing either said zero-related intermediate-value or said one-related intermediate-value from said third addition means to said 7-bit multiplexing means.

10. The carry select adder of claim 8, wherein:
said second addition means includes a said first addition means wherein said first adder means is zero-carry-loaded and said section-carry-out thereof, said higher-half value thereof, and said lower-half value thereof form a 7-bit zero-loaded intermediate-result.

11. A carry select process for adding two binary addends to produce a binary sum, comprising:
(a) adding 6-bit addend slices from the addends that each include a 3-bit lower-half slice and a 3-bit higher-half slice by:
(1) adding said lower-half slices and outputting a 1-bit adder-carry-out and a 3-bit lower-half value;
(2) adding said higher-half slices in a zero-carry-loaded manner and outputting a 4-bit zero-related intermediate-value;
(3) adding said higher-half slices in an one-carry-loaded manner and outputting a 4-bit one-related intermediate-value; and
(4) multiplexedly passing either said zero-related intermediate-value or said one-related intermediate-value as a 1-bit section-carry-out and a 3-bit higher-half value based on said adder-carry-out, wherein said higher-half value and said lower-half value form a 6-bit sum slice corresponding to said 6-bit addend slices; and
(b) outputting said sum slice on a result net.

12. The carry select process of claim 11, further comprising:
prior to said (a), receiving said lower-half slices and said higher-half slice from respective input nets carrying the addends.

13. The carry select process of claim 11, further comprising:
prior to said (a), receiving a 1-bit carry-in value, and wherein:
said (a)(1) is performed based on said 1-bit carry-in value.

14. The carry select process of claim 11, further comprising:
(c) adding at least one set of additional said addend slices the each respectively include an additional lower-half slice and an additional higher-half slice, by:
(1) calculating an additional zero-related intermediate-result based on said additional lower-half slices and said additional higher-half slices;
(2) calculating an additional one-loaded intermediate-result based on said additional lower-half slices and said additional higher-half slices; and
(3) multiplexedly passing either said additional zero-related intermediate-result or said additional one-related intermediate-result as an additional section-carry-out, an additional higher-half value, and an additional lower-half value based on said section-carry-out or another said additional section-carry-out, wherein said additional higher-half value and said additional lower-half value form an additional sum slice corresponding to said additional addend slices; and
(d) outputting said additional sum slice on said result net.
